(19) United States
(12) Patent Application Publication
(10) Pub. No.: US 2012/0247972 A1
(43) Pub. Date: Oct. 4, 2012

(54) PROCESS FOR REDUCING THE CONCENTRATION OF HYDRATE INHIBITORS IN WATER USED FOR OIL AND GAS PRODUCTION

(75) Inventors: Howard J. Spencer, Dukinfield (GB); Marc N. Lehmann, Houston, TX (US); Tudor C. Ionescu, Houston, TX (US); Timothy Z. Garza, Dickinson, TX (US); Steven J. Jackson, Liverpool (GB)

(73) Assignee: BAKER HUGHES INCORPORATED, HOUSTON, TX (US)

(21) Appl. No.: 13/427,540

(22) Filed: Mar. 22, 2012

Related U.S. Application Data
(60) Provisional application No. 61/469,930, filed on Mar. 31, 2011.

(51) Int. Cl. C02F 1/00; C02F 1/26; C02F 1/52; C02F 9/08; C02F 9/06; C02F 1/463; C02F 1/38; C02F 1/28; C02F 9/04; C02F 101/30

(52) U.S. Cl. 205/742; 210/691; 210/634; 210/702; 210/661; 210/660; 210/663

(57) ABSTRACT

Reducing the concentration of kinetic hydrate inhibitors in produced water may be accomplished by treating the produced water using a method selected from the group consisting of chemical adsorption, solvent extraction, chemical coagulation, electrochemical coagulation and combinations thereof. Such reductions may in some instances allow for the reuse of produced water for irrigation or recycle in oil and gas production.

### CROSS-REFERENCE TO RELATED APPLICATIONS

This application is claims priority from U.S. Provisional Patent Application Ser. No. 61/469,930, filed on Mar. 31, 2011, the disclosure of which is incorporated herein by reference in its entirety.

### BACKGROUND OF THE DISCLOSURE

1. Field of the Invention

The disclosure relates to reducing the concentration of hydrate inhibitors in water. The disclosure particularly relates to reducing the concentration of kinetic hydrate inhibitors in water used in producing oil and gas.

2. Background of the Art

A number of hydrocarbons, especially lower-boiling light hydrocarbons are known to combine with water to form hydrates. This is particularly common when the hydrocarbons and water are present in a fluid at a combination of low temperature and high pressure. The hydrates often exist in forms that are sufficiently insoluble in the fluid that they result in solids.

As with the handling of most fluids, solids in a hydrocarbon or natural gas fluid are, at best, a nuisance. In extreme cases, such solids may result in major problems for those practicing the production, handling and transport of these fluids. For example, it is not uncommon for hydrate solids to cause plugging and/or blockage of pipelines or transfer lines or other conduits, valves and/or safety devices and/or other equipment. It follows then that hydrocarbon hydrates have been of substantial interest to many industries, particularly the petroleum and natural gas industries.

There are at least two types of hydrate inhibitors in common use. One of these is the so called thermodynamic hydrate inhibitors. The other is the kinetic hydrate inhibitors. The term “kinetic hydrate inhibitor” refers to compositions that are capable of decreasing the rate of hydrate formation. These inhibitors are generally used as upstream additives during the production of oil and gas and end up in produced fluids. During the storage, shipment and even the refining of produced fluids, it may be desirable to separate the aqueous phase from the hydrocarbon phase. In at least some applications, the aqueous phases may retain levels of kinetic hydrate inhibitors that are too high for easy disposal or recycling of the aqueous phase fluid.

### SUMMARY OF THE INVENTION

In one aspect, the invention is a process for reducing the concentration of kinetic hydrate inhibitors in produced water. The process includes treating the produced water using a method selected from the group consisting of chemical adsorption, solvent extraction, chemical coagulation, electrochemical coagulation and combinations thereof.

In another aspect, the invention is a process for recycling produced water. The process includes first treating the produced water using a method selected from the group consisting of chemical adsorption, solvent extraction, chemical coagulation, electrochemical coagulation and combinations thereof; and then recycling the produced water so treated.

In still another aspect, the invention is a process for disposing of produced water. The process includes first treating the produced water using a method selected from the group consisting of chemical adsorption, solvent extraction, chemical coagulation, electrochemical coagulation and combinations thereof; and then disposing of the produced water so treated.

### DETAILED DESCRIPTION

In one embodiment, the invention is a process for reducing the concentration of kinetic hydrate inhibitors in produced water. For the purposes of this disclosure, the term kinetic hydrate inhibitor (sometimes denoted by the acronym KHI) means a composition that reduces the rate of hydrate formation in a fluid including at least one hydrocarbon capable of forming a hydrate and water. In one embodiment, a kinetic hydrate inhibitor suitable for use with the process of the disclosure is a water soluble polymer. In one embodiment, such a polymer will be insoluble and/or incompatible with hydrocarbons. Exemplary polymers include, but are not limited polymers and copolymers of acrylamides, maleimides and mixtures thereof. In one embodiment of the processes of the disclosure, such a polymer may be selected from the group consisting poly(vinylpyrrolidone) (PVP); poly(vinylcaprolactam) (PVCap); copolymers of vinylpyrrolidone and vinylcaprolactam; poly(N-methyl-N-vinylacetamide); copolymers of N-methyl-N-vinylacetamide and isopropyl methacrylamide; copolymers of N-methyl-N-vinylacetamide and acryloyl piperidine; copolymers of N-methyl N-vinylacetamide and methacryloyl pyrrolidine; and combinations thereof. In another embodiment, useful KHIs are selected from the group consisting of copolymers of N-methyl-N-vinylacetamide and acryloyl pyrrolidine; derivatives thereof; and mixtures thereof.

In an another embodiment, the kinetic hydrate inhibitors include, but are not limited to, acrylamide/maleimide copolymers such as dimethylacrylamide (DMAM) copolymerized with maleimide (ME), ethyl maleimide (EME), propyl maleimide (PME), and butyl maleimide (BME), for example. In still another embodiment, the KHIs include, but are not limited to, acrylamide/maleimide copolymers such as DMAM/methyl maleimide (DMAM/MME), and DMAM/cyclohexyl maleimide (DMAM/CHME), N-vinyl amide/maleimide copolymers, such as N-methyl-N-vinylacetamide/ethyl maleimide (VIMA/EME), and lactam maleimide copolymers, such as vinylcaprolactam ethylmaleimide (VCap/EME).

In yet another embodiment, the KHI includes poly (vinylcaprolactam). In still other embodiments the KHI may include one or more of halide salts of alkali metals and alkali earth metals, formate salts, alcohols, glycols, glycol amines, sugars, sugar alcohols, amidoamine oxides, polymers such as polyamines, polyvinylpyrrolidones and derivatives thereof, polyvinyl alcohols and derivatives thereof, polycaprolactams and derivatives thereof, and hydroxy ethylcellulose.

The process of the disclosure includes the removal of KHI from produced water. For the purposes of this disclosure, the term produced water includes water that is recovered from an oil or gas well. Generally, the produced water is first in the form of production fluid. The term production fluid means fluid produced from a well and includes at least one of crude hydrocarbons, formation water, natural gas, inorganic gases, and both organic and inorganic solids. Formation fluid may also include fluids added to the well or to a producing formation including additives, such as a KHI, water or other fluids from secondary or tertiary methods.

For the purposes of this disclosure, the term produced water may also include water that includes a composition that is a KHI, even if that water is not directly or even indirectly recovered from an oil well. For example, wash water used to clean vessels that include a KHI or water that was used to clean up a spill of a KHI is also within the scope of the term produced water. Any aqueous fluid that includes a KHI is produced water for the purposes of this disclosure.

In the practice of the processes of the disclosure, at least one embodiment includes using a chemical adsorption method to reduce the concentration of KHI in produced water. A chemical adsorption method includes contacting the produced water with an adsorbent. Suitable adsorbents include, but are not limited to activated charcoal, clays, and resins having surface groups effective at attracting and adhering KHIs.

This method may be employed in any way known to be useful to those of ordinary skill in the art of performing adsorption of components from an aqueous fluid. For example, in one embodiment, the produced water is passed through a bed of adsorbent. In another embodiment, the produced water is admixed with the adsorbent and then subjected to filtration. In still another embodiment, the produced water is admixed with the adsorbent and then subjected to centrifugation. Any method that includes contacting the produced water with and adsorbent and the separating the adsorbent from the produced water where the concentration of KHI is reduced may be used with the processes of the disclosure.

In the practice of the processes of the disclosure, another embodiment includes using solvent extraction method. In a solvent extract method, the produced water is admixed with a solvent and then separated. Any method of performing such an extraction known to those of ordinary skill in the art may be used with the processes of the disclosure. Such liquid-liquid extraction generally employs the principle of contacting a solute-bearing aqueous liquid, with an organic liquid having an affinity for the solutes. The liquid and organic phase are first mixed to promote transfer of solute from the aqueous to the organic phase, and then allowed to coalesce and settle by gravity whereupon at least a portion of the solute is now dispersed in the organic extractant phase. Reverse flow extractions where an aqueous phase and an organic phase are passed through each other and pumped into a common reservoir and separated by density is within the scope of methods useful with the processes of the disclosure.

In another embodiment, mixer-settlers can be used for liquid-liquid extraction. Mixer-settlers typically include a mixing chamber and a settling chamber. The organic extractant liquid and the aqueous liquid are normally mixed in the mixing chamber and then overflow into the settling chamber, where the phases are allowed to separate. The end of the settling chamber can include two weirs to separate out the liquid phases. Specifically, the lighter organic phase overflows into a first weir having an opening at the top of the tank, and the heavier aqueous phase flows into a second weir having an opening at the bottom of the tank.

Solvents useful with such methods include any that are compatible with the KHI but incompatible with water. For example, such solvents may include but are not limited to glycol ethers and acetates. Exemplary of such compounds are ethyl acetate, propylene glycol methyl ether, propylene glycol butyl ether, propylene glycol propyl ether, and the like.

Another method useful with some embodiments of the processes of the disclosure includes the use of coagulation and clarification. This process has the advantage of being well known in the treatment both municipal and industrial water processes. In this process, the produced water is treated with a coagulant which causes the KHI to form a floc which is, in turn, removed from the water via settling or filtering. Any method known to be useful for such a method may be employed in the practice of the processes of the disclosure. The use of alum and other flocculation aids is within the scope of the coagulation methods of the disclosure.

In yet another embodiment, the processes of the disclosure may be practiced using a method of electrochemical coagulation and clarification. In this embodiment, the KHI is reduced by coagulating the KHI by contacting the produced water with a metal surface having an electric potential across its surface. In one such embodiment, the process is practiced in the presence of a coagulation aid, such as alum.

The method of the disclosure wherein solids (including a floc) or liquids are separated from a fluid may be performed using any way of separating the solids or liquids from a known to those of ordinary skill in the art. For example, solids may be filtered. In another embodiment, liquids and/or solids may be separated using gravity or other means of acceleration. Exemplary of such acceleration would be centrugation.

The processes of the disclosure may be used to comply with the laws and regulations where they are practiced. For example, in arid regions water is quite precious and the simple disposal of large quantities may not be economically practical. The processes of the disclosure may be useful in meeting specifications necessary to reuse produced water for irrigation, for example.

The processes of the disclosure may also be useful in those situations where it is necessary to recycle produced water. One problem sometimes associated with KHIs is the fact that they may become unstable when recycled. If the KHI were to precipitate, it could, for example, plug or cause unwanted fracturing of a producing formation thereby lowering production rates.

### EXAMPLES

The following examples are provided to illustrate the present invention. The examples are not intended to limit the scope of the present invention and they should not be so interpreted. Amounts are in weight parts or weight percentages unless otherwise indicated.

The Examples were performed using a hyperbranched poly ester amide as the KHI. Sea water used in the Examples is actually a synthetic brine mimicking sea water.

### Example 1

### Adsorption

A solution of water and 1.5 wt % KHI in seawater is passed through a known amount of the filtration medium, the resulting water was either passed through a 0.45 μm filter or centrifuged to separate the adsorbent. The concentration of KHI was determined using a UV-Vis spectrometer before and after contacting the brine/KHI with the adsorbent. The experiments were conducted with the water samples at ambient temperature and at 70° C. The results are shown below in Table 1. The table shows that significant amounts of KHI may be removed using activated carbon and Crudesorb®.

### Example 2

### Solvent Extraction

50 ml aliquots containing 1.5 wt % KHI in DI water were extracted using 50 ml aliquot of PGBE (trade name Dowanol PnB). The samples were tested as in Example 1. The results are shown below in Table 2. The table shows that from about 65 to 85 percent of the KHI was removed using this method.

### Example 3

### Solvent Extraction (2)

A 50 ml aliquot containing 1.5 wt % KHI in DI water was extracted 3 times with ethyl acetate. The efficiency of the extraction was determined by evaporating the samples to dryness to determine the amount of solids extracted into the solvent and remaining in the water. The results are shown below in Table 3. This table shows that a significant amount of KHI may be extracted using this method.

### Example 4

### Chemical Coagulation and Clarification

A 50 ml aliquot of sea water including 1.5% KHI was first coagulated using NaOH to increase the pH to about 7 in the presence of a floc aid and compared to a control run at the same time. The efficiency of the treatment was determined by testing before and after KHI concentration using a UV/VIS spectrophotometer. This method resulted in reductions of from about 24 to about 30% of the KHI from the produced water.

### Example 5

### Electrochemical Coagulation and Clarification

A produced water is prepared using sea water and further including 1.5% KHI and a quaternized imidazoline corrosion inhibitor. The temperature of the produced water was heated to 70° C. and then the pH of the produced water was raised to 7-9. In some experiments 1000 ppm of Alum was added to enhance clarification. The water was passed through a chamber containing a number of metal plates (iron or aluminum) which had a potential of 220 VDC. The resulting water was passed through a #1 Whatman® filter and the residual amount of KHI measured by the UV-Vis method. The residence time of the water in the chamber was estimated to be around 15 seconds. Samples of the treated water were filtered and analyzed for residual KHI. All samples were measured against a control that was collected at the same time, as all samples in this set. The results are shown below in Table 4. This table shows that this method permitted the reduction of about 7 to about 26% if the KHI.

TABLE 1

| | | Water | | % KHI |
|---|---|---|---|---|
| Filtration | Separation | Temperature | % KHI | Removed per |
| Media | Method | (° C.) | Removed | g or Sorbent |
| Activated | 0.45 μm filter | Ambient | 6.8 | 0.422 |
| Charcoal | | | | |
| Crudesorb ® | 0.45 μm filter | Ambient | 19.1 | 0.820 |
| Activated | centrifuge | Ambient | 7.7 | 0.478 |
| Charcoal | | | | |
| Crudesorb ® | centrifuge | Ambient | 11.3 | 0.485 |
| Activated | 0.45 μm filter | 70 | 11.6 | 0.795 |
| Charcoal | | | | |
| Crudesorb ® | 0.45 μm filter | 70 | 11.0 | 0.542 |
| Activated | centrifuge | 70 | 22.3 | 1.53 |
| Charcoal | | | | |
| Crudesorb ® | centrifuge | 70 | 13.8 | 0.680 |

TABLE 2
Propylene Glycol Butyl Ether

| | | | % of KHI |
|---|---|---|---|
| Water | Initial Concentration of | Final Concentration of | Removed |
| Sample | KHI (ppm) | KHI (ppm) | (%) |
| 1 | 14,800 | 2346 | 84% |
| 2 | 14,800 | 2465 | 84% |
| 3 | 14,800 | 2648 | 82% |
| 4 | 14,800 | 3578 | 76% |
| 5 | 14,800 | 3166 | 79% |
| 6 | 14,800 | 4928 | 67% |
| 7 | 14,800 | 3751 | 75% |
| 8 | 14,800 | 2873 | 81% |

TABLE 3
Ethyl Acetate

| | Resulting | |
|---|---|---|
| | concentration of | % of KHI removed |
| Ethyl acetate wash | KHI in water (ppm) | (%) |
| 1 | 4940 | 67 |
| 2 | 3504 | 77 |
| 3 | 2660 | 82 |

TABLE 4

| Alum Added | # Iron Plates | # Aluminum | | |
|---|---|---|---|---|
| (ppm) | Used | Plates Used | pH | % KHI Removed |
| 0 | 9 | 0 | 7 | 6.9 |
| 1000 | 7 | 2 | 7 | 13.9 |
| 1000 | 17 | 2 | 7 | 25.8 |

What is claimed is:

1. A process for reducing the concentration of kinetic hydrate inhibitors in produced water comprising treating the produced water using a method selected from the group consisting of chemical adsorption, solvent extraction, chemical coagulation, electrochemical coagulation and combinations thereof.

2. The process of claim 1 wherein the kinetic hydrate inhibitor is a water soluble polymer.

3. The process of claim 1 wherein the method to reduce the concentration of kinetic hydrate inhibitors in produced water comprises contacting the produced water with an adsorbent.

4. The method of claim 3 wherein the adsorbent is selected from the group consisting of activated charcoal, clays, and resins having surface groups effective at attracting and adhering kinetic hydrate inhibitors.

5. The method of claim 4 wherein the produced water is passed through a bed of adsorbent.

6. The method of claim 4 wherein the produced water is admixed with the adsorbent and then subjected to filtration.

7. The method of claim 4 wherein the produced water is admixed with the adsorbent and then subjected to centrifugation.

8. The method of claim 1 wherein the method to reduce the concentration of kinetic hydrate inhibitors in produced water comprises solvent extraction of the produced water.

9. The method of claim 8 wherein the solvent extraction is performed using a solvent selected from the group consisting of glycol ethers and acetates.

10. The method of claim 9 wherein the glycol ethers and acetates are selected from the group consisting of ethyl acetate, propylene glycol methyl ether, propylene glycol butyl ether, propylene glycol propyl ether, and combinations thereof.

11. The method of claim 8 wherein the solvent extraction is performed using gravity.

12. The method of claim 8 wherein the solvent extraction is performed using centrifugation.

13. The method of claim 8 wherein the solvent extraction is performed employing a reverse flow extraction method.

14. The process of claim 1 wherein the method to reduce the concentration of kinetic hydrate inhibitors in produced water comprises treating the produced water using coagulation and clarification.

15. The process of claim 1 wherein the method to reduce the concentration of kinetic hydrate inhibitors in produced water comprises treating the produced water using electrochemical coagulation and clarification.

16. The process of claim 14 wherein the coagulation and clarification is performed using a coagulation aid.

17. The process of claim 16 wherein the coagulation aid is alum.

18. The process of claim 15 wherein the coagulation and clarification is performed using a coagulation aid.

19. The process of claim 18 wherein the coagulation aid is alum.

20. A process for recycling produced water comprising first treating the produced water using a method selected from the group consisting of chemical adsorption, solvent extraction, chemical coagulation, electrochemical coagulation and combinations thereof; and then recycling the produced water so treated.

21. The process of claim 20 wherein the produced water so treated is reused for irrigation or in oil and gas production

22. A process for disposing of produced water comprising a first treating the produced water using a method selected from the group consisting of chemical adsorption, solvent extraction, chemical coagulation, electrochemical coagulation and combinations thereof; and then disposing of the produced water so treated.
